(19) United States
(12) Patent Application Publication
(10) Pub. No.: US 2009/0281251 A1
(43) Pub. Date: Nov. 12, 2009

(54) Exterior material for electronic device comprising thermoplastic elastomer-resin alloy

(75) Inventors: Ah Hyun Bae, Suwon-si (KR); Geun Ho Lee, Yongin-si (KR); Hye Ran Yoon, Cheonan-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/292,398

(22) Filed: Nov. 18, 2008

(30) Foreign Application Priority Data
May 8, 2008 (KR) 10-2008-0042869

(51) Int. Cl. C08G 18/44

(52) U.S. Cl. 525/452

(57) ABSTRACT

An exterior material for an electronic device housing electronic parts is disclosed, wherein the exterior material is made of a thermoplastic elastomer-resin alloy comprising 1 to 99% by weight of a thermoplastic elastomer and 1 to 99% by weight of a resin. Particularly, provided is a thermoplastic elastomer alloy resin composition is provided that is suitable for use as interior materials for electronic devices with softness, color variety, impact resistance, water resistance, durability, abrasion resistance and rigidity.

### CROSS-REFERENCE TO RELATED APPLICATIONS

This application claims the benefit of Korean Patent Application No. 2008-0042869, filed on May 8, 2008 in the Korean Intellectual Property Office, the disclosure of which is incorporated herein by reference.

### BACKGROUND

1. Field

The present invention relates to an exterior material for electronic devices comprising a thermoplastic elastomer-resin alloy. More specifically, the present invention relates to an exterior material for electronic devices using a thermoplastic elastomer-resin alloy exhibiting softness, color variety, impact resistance, water resistance, durability, abrasion resistance and rigidity, while satisfying lightweightness and slimness, general requirements of electronic devices.

2. Description of the Related Art

The term “thermoplastic elastomer” refers to a polymeric material that is plasticized at high temperature, like plastics, and exhibits rubber-elastomeric properties at ambient temperature. That is, such a thermoplastic elastomer is a material between a rubber and a resin, which has both elasticity as the inherent characteristic of rubbers and plasticity as the inherent characteristic of thermoplastic resins.

The recent rapid increase in use of portable electronic devices such as MP3 players, camcorders, cellular phones, personal digital assistants (PDAs) and notebook computers has resulted in the need for lightweight and slim portable electronic devices.

In addition to the portable electronic devices, mobile electronic devices such as mobile cleaning machines including robot cleaning machines may collide with structures such as furniture or walls when in motion, which frequently results in breakage.

Accordingly, thermoplastic elastomers are now preferred as exterior materials of a variety of products, based on characteristics such as softness, color variety, impact resistance and water resistance. However, thermoplastic elastomers have a week mechanical strength (rigidity), as compared to resins, thus being insufficiently durable to be used exclusively as exterior materials.

As shown in FIG. 1, in conventional cases, to reinforce insufficient rigidity of thermoplastic elastomers as exterior materials, a thermoplastic elastomer 2 is subjected to double injection molding in conjunction with a resin on an electronic device case made of a metal or a synthetic resin 1, or the thermoplastic elastomer 2 is subjected to injection molding over the metal or synthetic resin 1 by over-molding (coating), to form the appearance of products. As a result, the products can be protected from external stimuli, based on the rigidity of the resin, and can be provided with impact resistance and soft texture due to the elasticity of the thermoplastic elastomer.

For example, Korean Patent No. 0696788 discloses an exterior material for electronic devices, comprising a case housing electronic components and a cover part made of ceramic or polyurethane to cover the outermost surface of the case. In accordance with this patent, materials for the case to provide mechanical strength are limited to metals such as steel, stainless steel or aluminum.

However, thermoplastic elastomers are different from resins in terms of thermodynamic structure, thus causing a significant deterioration in bonding strength therebetween. Accordingly, the patent imparts a predetermined roughness to the external surface of the case to increase the bonding force between the case and the cover part.

In addition, the afore-mentioned methods, i.e., the double injection of the synthetic resin together with the thermoplastic elastomer, and coating the thermoplastic elastomer over the metal or synthetic resin, inhibit production of slim and lightweight products. These methods mostly result in formation of double-structures by separate moldings, thus disadvantageously involving increased preparation costs. In addition, these methods employ synthetic resins and metals as exterior materials, thus disadvantageously making it almost impossible to achieve sufficient shock absorption upon collision.

Furthermore, there are several conventional methods for preparing thermoplastic elastomer-resin alloys, based on dynamic vulcanization techniques or dynamic crosslinking techniques using additives such as mixing agents and crosslinking agents (e.g., Korean Patent Laid-open Publication Nos. 1999-0021569, 1999-0054418, 1995-0003370, 2007-0027653, 2006-0120224, and the like).

These conventional methods suffer from numerous disadvantages, including requiring use of other compounds such as mixing agents, fillers, initiating agents and crosslinking agents and taking an excessively long time to synthesize or polymerize thermoplastic elastomers and resins. In addition, conventional thermoplastic elastomer-resin alloys have a strict restriction in that the thermoplastic elastomers and resins must be selected from those that have mutual chemical affinity.

### SUMMARY

Therefore, in an attempt to solve the problems of the prior art, it is an aspect of the present invention to provide an exterior material for electronic devices, using a thermoplastic elastomer alloy that secures softness, color variety, impact resistance, water resistance, durability, abrasion resistance and rigidity via physical modification, rather than chemical decomposition.

It is another aspect of the present invention to provide an exterior material for electronic devices using thermoplastic elastomers and resins that have low mutual chemical affinity, in comparison to the prior art.

In accordance with one aspect of the invention, an exterior material is provided for an electronic device housing electronic parts, wherein the exterior material is made of a thermoplastic elastomer-resin alloy comprising 1 to 99% by weight of a thermoplastic elastomer and 1 to 99% by weight of a resin.

Preferably, the thermoplastic elastomer is at least one selected from the group consisting of thermoplastic urethane elastomers (hereinafter, referred to as “TPU”), thermoplastic ester elastomers, thermoplastic styrene elastomers, thermoplastic olefin elastomers, thermoplastic polyvinyl chloride elastomers and thermoplastic amide elastomers.

Preferably, the resin is a thermoplastic plastic.

More preferably, the thermoplastic plastic is at least one selected from the group consisting of polyvinyl chloride, polystyrene, polyethylene, polypropylene, acryl, nylon, polycarbonate (hereinafter, referred to as “PC”), polymethyl methacrylate (PMMA) and acrylonitrile butadiene styrene (ABS) copolymers.

The exterior material for electronic devices comprising a thermoplastic elastomer-resin alloy of the present invention employs, as an exterior material for electronic devices, the thermoplastic elastomer-resin alloy prepared via physical modification, rather than chemical decomposition, without using any chemical such as mixing agents, fillers, initiating agents and crosslinking agents.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view illustrating an exterior material according to the prior art, wherein a thermoplastic elastomer is over-molded over a resin;

FIG. 2 is a perspective view of a thermoplastic elastomer-resin alloy of the present application used as an exterior material for a cellular phone; and

FIG. 3 is a cross-sectional view taken along the line A-A′ of FIG. 2.

### DETAILED DESCRIPTION OF EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, a method for preparing the thermoplastic elastomer-resin alloy will be illustrated in detail.

(1) Feeding Materials

A thermoplastic elastomer and a resin to prepare the thermoplastic elastomer-resin alloy were dried in a dehumidifying dryer, 1 to 99% by weight of the thermoplastic elastomer and 1 to 99% by weight of the resin were fed into respective feeder hoppers, and were then subjected to calibration.

Preferably, the resin is a thermoplastic plastic which is flowable at high temperatures. The thermoplastic plastic includes all plastics that are plasticized in a molten state by heating, and that freeze when cooled.

Examples of thermoplastic plastics include, but are not limited to polyvinyl chloride (PVC), polystyrene (PS), polyethylene (PE), polypropylene (PP), acryl, nylon (PA), polycarbonate (PC), polymethyl methacrylate (PMMA) and acrylonitrile-butadiene-styrene (ABS) copolymers.

When the content of the thermoplastic elastomer is excessively low, mechanical properties or oil resistance may be deteriorated. Meanwhile, when the content of the thermoplastic elastomer is excessively high, elasticity may be deteriorated.

(2) Mixing and Heating

Next, the thermoplastic elastomer was mixed with the resin with stirring in a compounder at a rate of 40 to 100 rpm. At this time, while varying ratios of the thermoplastic elastomer to resin, the mixture was heated to 200 to 250° C. in a compounder and was then cooled to 50 to 110° C. in a cooling bath.

The compounder may be a melt kneader conventionally used for preparing or processing resins or thermoplastic elastomers. Here, any compounder may be used without particular limitation so long as it can simultaneously apply heat and shearing force. Specific examples of compounders include open-type mixing rolls, pressure kneaders, continuous co-rotating twin-screw extruders, continuous counter-rotating twin-screw extruders and twin-screw kneaders.

The heating conditions may be varied depending on the type of resin and thermoplastic elastomer used, the ratio therebetween and the type of melt kneader used. The heating temperature is preferably in the range of 200 to 250° C.

(3) Molding

The cooled thermoplastic elastomer-resin mixture was molded into a pellet using a pelletizer.

Accordingly, the thermoplastic elastomer-resin alloy thus prepared exhibits superior elasticity, soft texture, heat resistance, mechanical strength, rigidity and impact resistance, thus being useful for exterior/interior materials of various electronic devices.

The thermoplastic elastomer-resin alloy of the present invention will now be described in further detail with reference to the following examples. These examples are for illustrative purposes only and are not intended to limit the scope of the present invention.

### COMPARATIVE EXAMPLE 1

10 Kg of PC was dried in a dehumidifying dryer and was injected into a feeder hopper. After the resulting PC was fed into a compounder, the compounder was heated to 260° C., while stirring at 40 to 100 rpm. The heated PC was cooled to 55° C., was pelletized and was molded into a specimen (width: 1.27 cm, length: 6 cm, thickness: 1.8 mm) using an injection molding machine.

### EXAMPLE 1

9.9 Kg of PC and 0.1 Kg of TPU were dried in a dehumidifying dryer and were then injected into respective feeder hoppers. The resulting PC and TPU were fed into a compounder, and were then heated to 250° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 2

9 Kg of PC and 1 Kg of TPU were dried in a dehumidifying dryer and were then injected into respective feeder hoppers. The resulting PC and TPU were fed into a compounder, and were then heated to 250° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 3

7 Kg of PC and 3 Kg of TPU were dried in a dehumidifying dryer and were then injected into respective feeder hoppers. The resulting PC and TPU were fed into a compounder, and were then heated to 240° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 4

5 Kg of PC and 5 Kg of TPU were dried in a dehumidifying dryer and were then injected into respective feeder hoppers. The resulting PC and TPU were fed into a compounder, and were then heated to 230° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 5

3 Kg of PC and 7 Kg of TPU were dried in a dehumidifying dryer and were then injected into respective feeder hoppers. The resulting PC and TPU were fed into a compounder, and were then heated to 220° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 6

1 Kg of PC and 9 Kg of TPU were dried in a dehumidifying dryer and were then injected into respective feeder hoppers. The resulting PC and TPU were fed into a compounder and were then heated to 250° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### EXAMPLE 7

0.1 Kg of PC and 9.9 Kg of TPU were dried in a dehumidifying dryer and were then injected into respective feeder hoppers. The resulting PC and TPU were fed into a compounder and were then heated to 250° C., while stirring at 40 to 100 rpm. The heated mixture was cooled to 55° C., was pelletized and was molded into a specimen (width: 1.27 cm, length: 6 cm, thickness: 1.8 mm) using an injection molding machine.

### COMPARATIVE EXAMPLE 2

10 Kg of TPU was dried in a dehumidifying dryer and was injected into a feeder hopper. The resulting TPU was fed into a compounder and was then heated to 170° C., while stirring at 40 to 100 rpm. The heated TPU was cooled to 55° C., was pelletized and was molded into a specimen (width: 1.27 cm, length: 6 cm, thickness: 1.8 mm) using an injection molding machine.

### EXPERIMENTAL EXAMPLE

The physical properties of the thermoplastic elastomer-resin alloy according to the present invention are shown in Table 1 below.

TABLE 1

| | | | Specific | | Strain | Tensile | | Tear |
|---|---|---|---|---|---|---|---|---|
| | | Hardness | gravity | Modulus | modulus | strength | Elongation | strength |
| Types | Appearance | (shore D) | (g/cm³) | (Kgf/cm²) | (%) | (Kgf/cm²) | (%) | (kgf/cm) |
| Comp. | — | 80 | 1.18 | 16,500 | 6.3 | 560 | 80 | 270 |
| Ex. 1 | | | | | | | | |
| Ex. 1 | gel | 80 | 1.18 | 16,400 | 6.3 | 560 | 80 | 268 |
| Ex. 2 | gel | 79 | 1.18 | 18,700 | 6 | 580 | 8 | 190 |
| Ex. 3 | good | 70 | 1.19 | 10,000 | 9 | 400 | 100 | 190 |
| Ex. 4 | good | 65 | 1.19 | 2,840 | x | 270 | 140 | 110 |
| Ex. 5 | | 50 | 1.19 | 610 | x | 210 | 350 | 95 |
| Ex. 6 | | 42 | 1.19 | 85 | x | 400 | 620 | 120 |
| Ex. 7 | | 40 | 1.19 | 143 | x | 570 | 708 | 111 |
| Comp. | | 40 | 1.19 | 145 | x | 575 | 710 | 110 |
| Ex. 2 | | | | | | | | |

As can be seen from Table 1 above, as the content of the resin increases, the hardness, tensile strength and tear strength increase, thus causing improvement in rigidity and abrasion resistance, and as the content of the thermoplastic elastomer increases, the elongation increases, thus causing improvement in elasticity. Accordingly, the thermoplastic elastomer-resin alloy composition of the present invention can be suitably applicable as interior/exterior materials to electronic devices according to the characteristics of the electronic devices.

For example, portable devices such as MP3 players, camcorders, cellular phones, personal digital assistants (PDAs), notebook computers, digital cameras and cameras that are required not only to be lightweight and slim, but also elastic and soft, may employ the thermoplastic elastomer-resin alloys of Examples 4 to 6.

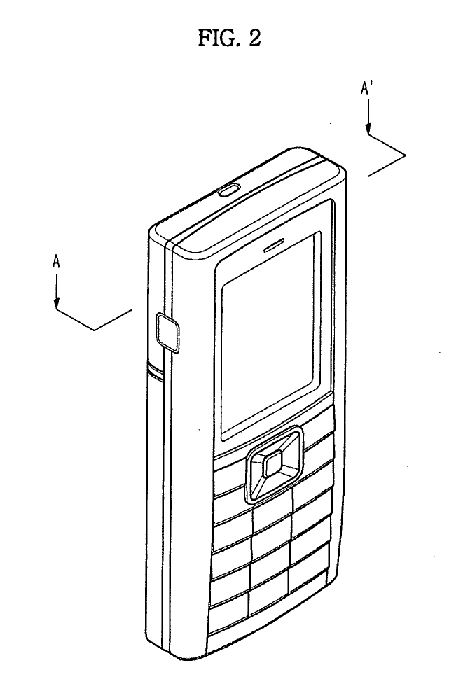

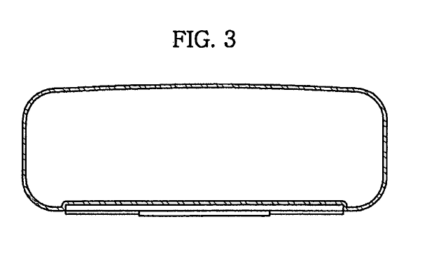

FIG. 2 is a perspective view of a thermoplastic elastomer-resin alloy of the present invention used as an exterior material for a cellular phone. FIG. 3 is a cross-sectional view taken along the line A-A′ of FIG. 2.

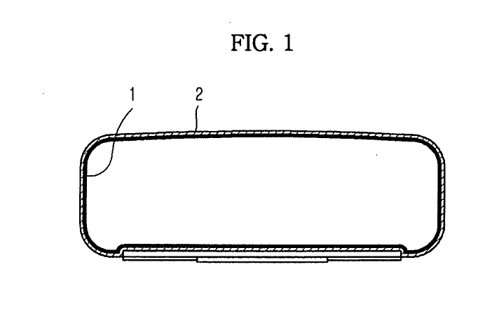

As shown in FIG. 3, the present invention can realize lightweight and slim cellular phones, in comparison to conventional double-injection or over-molding, as shown in FIG. 1.

Furthermore, for example, mobile electronic devices including cleaning machines e.g. robot cleaning machines that further require rigidity and abrasion resistance may use thermoplastic elastomer-resin alloys of Examples 2 to 4 as exterior materials for electronic devices.

Meanwhile, physical and thermal properties of the thermoplastic elastomer-resin alloy composition of the present invention will be illustrated in more detail. PC as a resin and TPU as a thermoplastic elastomer were mixed in various ratios to prepare thermoplastic elastomer-resin alloys, as set forth in Table 2 below. The physical and thermal properties of the thermoplastic elastomer-resin alloys were evaluated.

TABLE 2

| Properties | PC:TPU = 10:0 | PC:TPU = 9:1 | PC:TPU = 8:2 | PC:TPU = 7:3 | PC:TPU = 6:4 | PC:TPU = 5:5 | PC:TPU = 0:10 |
|---|---|---|---|---|---|---|---|
| Rockwell | 110 | 109 | 98 | 89 | 71 | 53 | — |
| hardness | | | | | | | |
| Melt index | 20 | 48 | 97 | 190 | 215 | 230 | — |
| Young's | 1,640 | 1,700 | 1,400 | 1,050 | 620 | 300 | 150 |
| modulus | | | | | | | |
| Tensile | 59 | 55 | 44 | 35 | — | — | — |
| strength at | | | | | | | |
| yield point | | | | | | | |
| Tensile | 57 | 58 | 61 | 41 | 35 | 30 | 31 |
| strength at | | | | | | | |
| break point | | | | | | | |
| Elongation | 6.4 | 5.7 | 6.1 | 8.2 | — | — | — |
| at yield | | | | | | | |
| point | | | | | | | |
| Elongation | 83 | 100 | 100 | 90 | 108 | 115 | 450 |
| at break | | | | | | | |
| point | | | | | | | |
| Flexural | 88 | 84 | 67 | 50 | 33 | 17 | 3 |
| strength | | | | | | | |
| Flexural | 1,920 | 1,900 | 1,460 | 1,050 | 640 | 280 | 41 |
| modulus | | | | | | | |
| Impact | 660 | 580 | 560 | 450 | 410 | 380 | NB |
| strength at | | | | | | | |
| 23° C. | | | | | | | |
| Thermal | 117 | 103 | 98 | 88 | 73 | 50 | — |
| deflection | | | | | | | |
| temperature | | | | | | | |

Rockwell hardness: ASTM D785 (unit: g/cm³)
Melt index: ASTM D1238 (unit: g/10 min)
Tensile strength and elongation: ASTM D638 (tensile strength unit: MPa, elongation unit; %)
Flexural strength and Flexural modulus: ASTM D790 (unit: MPa)
Impact strength: ASTM D256 (unit: J/m)
Thermal deflection temperature: ASTM D648 (unit: ° C.)

As can be seen from Table 2 above, as the content of PC increases, Rockwell hardness, tensile strength, flexural strength, flexural modulus, impact strength, and heat deflection temperature increase. Accordingly, rigidity, abrasion resistance and impact resistance, as the requirements of exterior materials, are improved, and as the content of TPU increases, the melt index increases. Accordingly, as the content of TPU increases, processability is increased. Consequently, the thermoplastic elastomer-resin alloy of the present invention exhibits rigidity and abrasion resistance required for exterior materials, and secures high processability and softness.

In other words, as can be seen from Table 2, the thermoplastic elastomer-resin alloy composition of the present invention exhibits superior mechanical properties, heat resistance and processability.

### EXPERIMENTAL EXAMPLE 2

The thermoplastic elastomer-resin alloy composition was compared with the prior art (Korean patent Laid-open No. 1999-021569). The comparison results in the impact strength and heat deflection temperature of various physical properties are shown in Table 3.

TABLE 3

| Properties | The present invention | Prior art |
|---|---|---|
| Impact strength | 380~580 | 12~18 |
| Thermal deflection | 50~105 | About 80° C. |
| temperature (° C.) | | |

As can be seen from Table 3 above, the present invention provides about a 20-fold increase in impact strength, as compared to the prior art and can control heat deflection temperature according to modification in ratios of PC and TPU.

That is, in comparison to the prior art, the present invention enables preparation of a thermoplastic elastomer-resin alloy composition that exhibits superior physical properties in a relatively simple manner without adding any other compounds such as mixing agents, fillers, initiating agents and crosslinking agents.

According to the present invention, it is possible to obtain an exterior material for electronic devices comprising a thermoplastic elastomer-resin alloy that has both the characteristics of thermoplastic elastomers (e.g., elasticity, soft texture, impact absorption, color variety and waterproofing) and the characteristics of resins (e.g., mechanical strength and rigidity). Furthermore, the novel thermoplastic elastomer-resin alloy of the present invention can be commercialized into electronic devices by general injection molding, thus reducing processing costs and time, while realizing slim and lightweight electronic devices.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An exterior material for an electronic device housing electronic parts, wherein the exterior material is made of a thermoplastic elastomer-resin alloy comprising 1 to 99% by weight of a thermoplastic elastomer and 1 to 99% by weight of a resin.

2. The exterior material according to claim 1, wherein the thermoplastic elastomer is at least one selected from the group consisting of thermoplastic urethane elastomers, thermoplastic ester elastomers, thermoplastic styrene elastomers, thermoplastic olefin elastomers, thermoplastic polyvinyl chloride elastomers and thermoplastic amide elastomers.

3. The exterior material according to claim 1, wherein the resin is a thermoplastic plastic.

4. The exterior material according to claim 3, wherein the thermoplastic plastic is at least one selected from the group consisting of polyvinyl chloride (PVC), polystyrene (PS), polyethylene (PE), polypropylene (PP), acryl, nylon (PA), polycarbonate (PC), polymethyl methacrylate (PMMA) and acrylonitrile butadiene styrene (ABS) copolymers.

5. The exterior material for an electronic device housing electronic parts, wherein the exterior material comprises the thermoplastic elastomer that is 10 to 30% by weight of a thermoplastic urethane elastomer and the resin that is 90 to 70% by weight of a polycarbonate.

6. The exterior material for an electronic device housing electronic parts, wherein the exterior material comprises the thermoplastic elastomer that is 20 to 40% by weight of a thermoplastic urethane elastomer and the resin that is 80 to 60% by weight of a polycarbonate.

7. The exterior material for an electronic device housing electronic parts, wherein the exterior material comprises the thermoplastic elastomer that is 30 to 50% by weight of a thermoplastic urethane elastomer and the resin that is 70 to 50% by weight of a polycarbonate.

8. The exterior material for an electronic device housing electronic parts, wherein the exterior material comprises the thermoplastic elastomer that is 40 to 60% by weight of a thermoplastic urethane elastomer and the resin that is 60 to 40% by weight of a polycarbonate.

9. The exterior material for an electronic device housing electronic parts, wherein the exterior material comprises the thermoplastic elastomer that is 50 to 70% by weight of a thermoplastic urethane elastomer and the resin that is 50 to 30% by weight of a polycarbonate.
